(19) United States
(12) Patent Application Publication
(10) Pub. No.: US 2007/0276915 A1
(43) Pub. Date: Nov. 29, 2007

(54) MANAGING MESSAGES BETWEEN MULTIPLE WIRELESS CARRIERS TO MULTIPLE ENTERPRISES USING A RELATIVELY LIMITED NUMBER OF IDENTIFIERS

(75) Inventors: Larry A. Setlow, Redmond, WA (US); Thomas J. Cast, Redmond, WA (US); Alan Cedric Lindsay, Edmonds, WA (US); Curtis L. Miller, Sammamish, WA (US); Eric Edgar Lofdahl, Kent, WA (US); John Henry Kuhlmann, Redmond, WA (US)

Correspondence Address: DARBY & DARBY P.C., P.O. BOX 770, Church Street Station, New York, NY, 10008-0770, US

(73) Assignee: Wireless Services Corp., Seattle, WA (US)

(21) Appl. No.: 11/838,763

(22) Filed: Aug. 14, 2007

Related U.S. Application Data
(63) Continuation-in-part of application No. 11/397,329, filed on Apr. 4, 2006.

(51) Int. Cl. G06F 15/16

(52) U.S. Cl. 709/206

(57) ABSTRACT

Identifying a reply message using a relatively limited number of message source identifiers divided among multiple enterprises. In an exemplary embodiment, a message is sent with a source device to one or more target mobile devices on one or more wireless carriers. Each target mobile device can be associated with multiple enterprises. A gateway assigns one of a limited number of long codes to the message for each wireless carrier. The long code is selected from a sub-block of long codes that are associated with one of the multiple enterprises. Each long code identifies the gateway as a return address for the message. Upon receiving a second message, addressed to the long code, the gateway examines an associated target mobile device inbox for a message assigned the same long code. If a matching message exists, the gateway interprets the second message is a reply to the first message.

### CROSS-REFERENCE TO RELATED APPLICATIONS

This is a continuation-in-part (CIP) application and claims the benefit under 35 U.S.C. 120 of U.S. patent application Ser. No. 11/397,329 filed Apr. 4, 2006, the contents of which are hereby incorporated by reference.

### FIELD OF ART

The present invention is directed to managing messages between users of electronic devices, and more specifically to identifying related messages to enable reply to users of multiple groups, wherein the messages are communicated via one or more wireless carriers and using a number of identifiers less than the possible number of messages.

### BACKGROUND

Text messages, multimedia messages, and other messages have become an increasingly popular method of communication, especially with mobile devices such as cellular telephones, personal data assistants (PDAs), and the like. Such messages are generally inexpensive to send and receive relative to some voice communications, and can be communicated to multiple electronic devices at the same time. Messages can be exchanged across a variety of protocols, including those for telephones, email systems, web-based message portals, and other network systems. Some exemplary message protocols include short message peer to peer (SMPP), multimedia service (MMS), simple network paging protocol (SNPP), simple mail transport protocol (SMTP), post office protocol (POP), wireless communications transfer protocol (WCTP), hypertext transport protocol (HTTP), and the like.

Relationships between messages can be maintained when sending and receiving devices can be uniquely identified. For example, original messages and replies between devices can be associated with each other based on device identifiers, such as telephone numbers and the like. With a large number of sending and receiving devices, a relatively limited number of identifiers may be available for communicating with the devices. The relatively limited number of identifiers may be allocated by a communication carrier, such as a telephone carrier, for a messaging system to manage messages among devices associated with the carrier and/or to manage messages between devices of multiple carriers. If the number of allocated identifiers is insufficient to identify all of the sending and receiving devices, message relationships may be difficult to identify. Receiving devices may be associated with multiple enterprises at the same time. This may compound the difficulty of identifying message relationships and ensuring that reply messages reach the correct receiving device within the correct enterprise.

### BRIEF DESCRIPTION OF THE DRAWINGS

FIG. 1 shows a functional block diagram of an exemplary server according to one embodiment of the invention;

FIG. 2 shows a functional block diagram of an exemplary mobile device according to one embodiment of the invention

FIG. 3 is a functional block diagram illustrating an overall architecture of an exemplary embodiment of the present invention;

FIG. 4 is a functional block diagram illustrating a more detailed architecture of an exemplary embodiment of the present invention;

FIG. 5 is a flow diagram illustrating exemplary logic for initiating a message from an enterprise user to one or more other enterprise clients;

FIG. 6 is a flow diagram illustrating exemplary logic for determining whether a message from an enterprise client is a reply;

FIG. 7 is a flow diagram illustrating exemplary logic for initiating a message from an enterprise user to one or more clients that are associated with multiple enterprises;

FIG. 8 is a flow diagram illustrating exemplary logic for determining whether a message from an enterprise client is a reply and associating the reply with the correct enterprise user.

### DETAILED DESCRIPTION

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” means a direct connection between the things that are connected, without any intermediary devices or components. The term “coupled,” or “in communication with” means a direct connection between the things that are connected, or an indirect connection through one or more either passive or active intermediary devices or components. The meaning of “a,” “an,” and “the” include plural references. The meaning of “in” includes “in” and “on.” The term “or” is an inclusive “or” operator, and includes the term “and/or,” unless the context clearly dictates otherwise. The phrase “in one embodiment,” as used herein does not necessarily refer to the same embodiment, although it may. Similarly, the phrase “in another embodiment,” as used herein does not necessarily refer to a different embodiment, although it may. The term “based on” is not exclusive and provides for being based on additional factors not described, unless the context clearly dictates otherwise. The term “user” can include a computer user, a mobile device user, an online service subscriber, and/or other person using an electronic device. The term “message” can include a copy of the a message.

Briefly stated, embodiments of the invention are direct to methods and systems for identifying a message as a reply from a receiver that is associated with multiple enterprises, to a sender from one of those enterprises, using a relatively limited number of communication identifiers. In at least one embodiment, the inventive use of those identifiers provides a high-probability of associating a reply r, sent from a subscriber s, to identifier i, with an original message sent to subscriber s using identifier i. When the number of identifiers is limited, it is possible that the association between specific messages may be incorrect. Nevertheless, embodiments of the present invention ensure that the reply is associated with the correct sender.

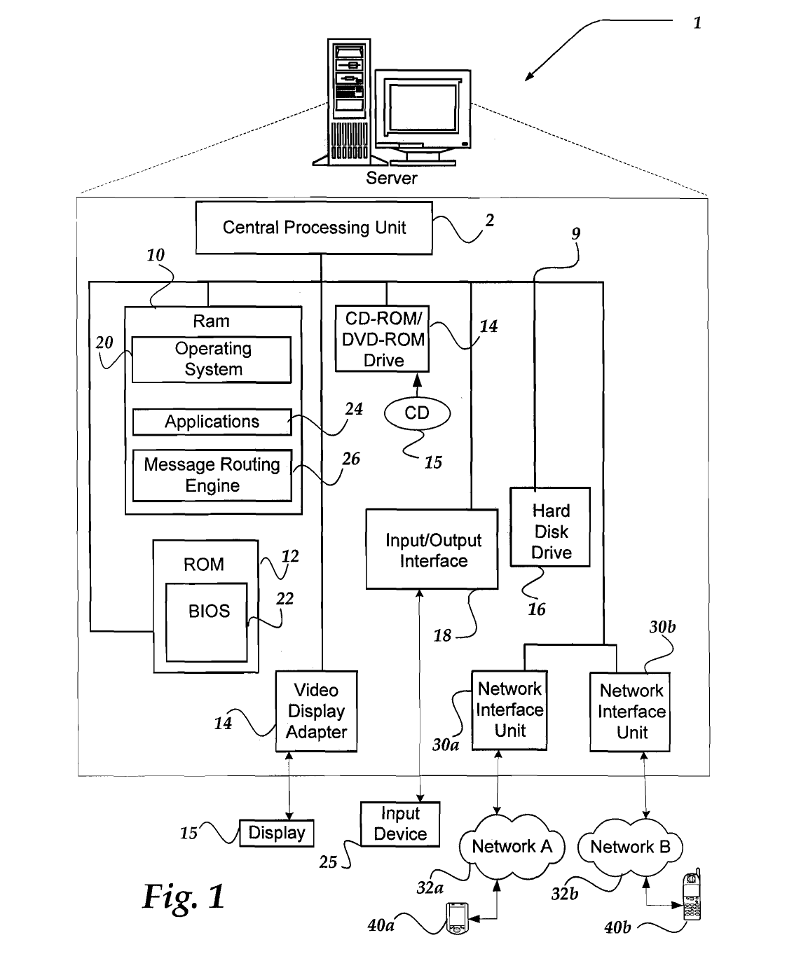

FIG. 1 shows a functional block diagram of an exemplary server 10, according to one embodiment of the invention. Server 10 may include many more components than those shown. The components shown, however, are sufficient to disclose an illustrative embodiment for practicing the invention. Client devices can be similarly configured. Client devices can include, but are not limited to, other servers, personal computers (PCs), PDAs, mobile devices (e.g., cell phones), voice mail systems, and the like. A recipient can also receive messages via other forms of communication, such as fax, voice mail, postal mail, and the like.

FIG. 1 shows a functional block diagram of an exemplary server according to one embodiment of the invention. Server 1 includes a processing unit 2, a video display adapter 4 that can drive a display 5, and a mass memory, all in communication with each other via a bus 9. The mass memory generally includes RAM 10, ROM 12, and one or more permanent mass storage devices, such as an optical drive 14 that can read a machine readable medium such as a CD 15, a hard disk drive 16, a tape drive, a floppy disk drive, and/or the like. The mass memory stores an operating system 20 for controlling the operation of server 1. Any general-purpose operating system may be employed. A basic input/output system (“BIOS”) 22 is also provided for controlling low-level operation of server 1.

The mass memory also includes computer-readable media, such as volatile, nonvolatile, removable, and non-removable media implemented in any method or technology for storage of information, such as computer readable instructions, data structures, program modules, or other data. Examples of computer-readable media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computing device.

The mass memory also stores program code and data. One or more applications 24 are loaded into mass memory and run on operating system 20. Examples of application programs include database programs, schedulers, transcoders, calendars, web services, word processing programs, spreadsheet programs, email programs, and so forth. Mass storage may further include applications such as a message routing engine 26 for managing communication to and from clients.

Server 1 also includes input/output interface 18 for communicating with external devices, such as a mouse, keyboard, scanner, or other input device 19. Server 1 can communicate with a local network, the Internet, a telephone network, or some other communications network via network interface units 30a and 30b, which are constructed for use with various communication protocols including transmission control protocol/Internet protocol (TCP/IP), user datagram protocol (UDP), code division multiple access (CDMA), time division multiple access (TDMA), global system for mobile communications (GSM), Institute for Electrical and Electronics Engineers (IEEE) 802.11, IEEE 802.16 (WiMax), SMS, general packet radio service (GPRS), Wireless Application Protocol (WAP), and the like. Network interface units 20a and 20b are sometimes known as transceivers, transceiving devices, network interface cards (NICs), and the like. The network interface units can facilitate communications between computing devices that conform to the same or differing communication protocols. For example, network interface units 30a and 30b are illustrated as communicating with networks 32a and 32b, which may comprise cellular telephone carrier networks, the Internet, and/or other networks. Networks 32a and 32b provide communication services for clients such as clients 40a and 40b.

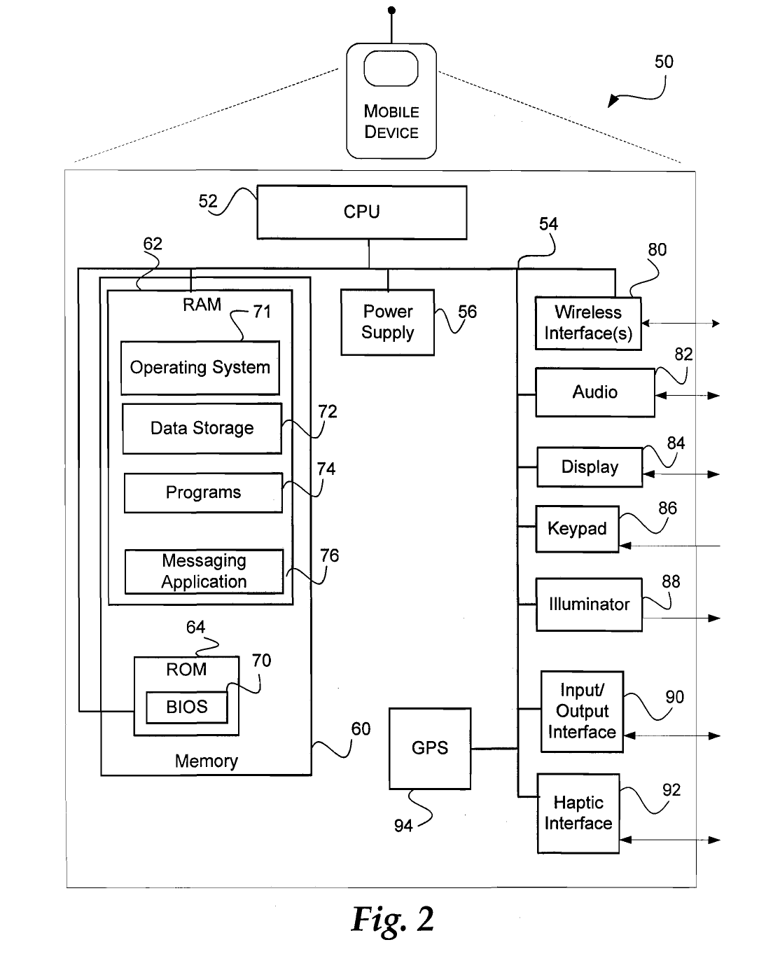

FIG. 2 shows an exemplary mobile device 50, according to one embodiment of the invention. In one embodiment, mobile device 50 is a cellular telephone that is arranged to send and receive voice communications and messages such as SMS messages via one or more wireless communication interfaces. Generally, mobile device 50 may comprise any personally mobile electronic device. Oftentimes, mobile electronic devices will be capable of personal communication by connecting to one or more wireless networks, connecting to multiple nodes of a single wireless network, communicating over one or more channels to one or more networks, or otherwise engaging in one or more communication sessions. Such devices include cellular telephones, smart phones, pagers, radio frequency (RF) devices, infrared (IR) devices, integrated devices combining one or more of the preceding devices, and the like. Mobile device 50 may also comprise other electronic devices such as Personal Digital Assistants (PDAs), handheld computers, personal computers, multiprocessor systems, microprocessor-based or programmable consumer electronics, network PCs, wearable computers, and the like.

Mobile device 50 may include many more components than those shown in FIG. 2. However, the components shown are sufficient to disclose an illustrative embodiment for practicing the present invention. As shown in the figure, mobile device 50 includes a processing unit 52 in communication with a mass memory 60 via a bus 54.

Mass memory 60 includes a RAM 62, a ROM 64, and other storage means. Mass memory 60 illustrates another example of computer storage media for storage of information such as computer readable instructions, data structures, program modules or other data. Mass memory 60 stores a basic input/output system (“BIOS”) 70 for controlling low-level operation of mobile device 50. The mass memory also stores an operating system 71 for controlling the operation of mobile device 50. It will be appreciated that this component may include a general purpose operating system such as a version of UNIX, or LINUX™, or a specialized mobile communication operating system such as Windows Mobile™, or the Symbian® operating system. The operating system may include, or interface with a virtual machine module, such as a Java virtual machine module, that enables control of hardware components and/or operating system operations via application programs, such as Java application programs and the like.

Memory 60 further includes one or more data storage units 72, which can be utilized by mobile device 50 to store, among other things, programs 74 and/or other data. Programs 74 may include computer executable instructions which, when executed by processor 52 and/or other components of mobile device 50, transmit, receive, and/or otherwise process data such as text, audio, video, web pages and/or other data. Other examples of application programs include calendars, contact managers, task managers, transcoders, database programs, word processing programs, spreadsheet programs, games, and so forth. In addition, mass memory 60 stores software messaging client 76. Software messaging client 76 may include computer executable instructions, which may be run under control of operating system 71 to enable telecommunication with another user of another mobile or non-mobile device and/or manage SMS, MMS, IM, email, and/or other messaging services for mobile device 50.

Mobile device 50 also includes a power supply 56, one or more wireless interfaces 80, an audio interface 82, a display 84, a keypad 86, an illuminator 88, an input/output interface 90, a haptic interface 92, and an optional global positioning systems (GPS) receiver 94. Power supply 56 provides power to mobile device 50. A rechargeable or non-rechargeable battery may be used to provide power. The power may also be provided by an external power source, such as an AC adapter or a powered docking cradle that supplements and/or recharges a battery.

Mobile device 50 may optionally communicate with a base station (not shown), or directly with another mobile device. Wireless interface 90 includes circuitry for coupling mobile device 50 to one or more wireless networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), Wireless Application Protocol (WAP), ultra wide band (UWB), IEEE 802.16 Worldwide Interoperability for Microwave Access (WiMax), and the like.

Audio interface 82 is arranged to produce and receive audio signals such as the sound of a human voice. For example, audio interface 82 may be coupled to a speaker and microphone (not shown) to enable telecommunication with others and/or generate an audio acknowledgement for some action. Display 84 may be a liquid crystal display (LCD), gas plasma, light emitting diode (LED), or any other type of display used with a mobile device. Display 84 may also include a touch sensitive screen arranged to receive input from an object such as a stylus or a digit from a human hand.

Keypad 86 may comprise any input device arranged to receive input from a user. For example, keypad 86 may include a push button numeric dial, or a keyboard. Keypad 86 may also include command buttons that are associated with capturing, selecting, and/or sending images and/or other data. Illuminator 88 may provide a status indication and/or provide light. Illuminator 88 may remain active for specific periods of time or in response to events. For example, when illuminator 88 is active, it may backlight the buttons on keypad 86 and stay on while the mobile device is powered. Also, illuminator 88 may backlight these buttons in various patterns when particular actions are performed, such as dialing another mobile device. Illuminator 88 may also cause light sources positioned within a transparent or translucent case of the mobile device to illuminate in response to actions.

Mobile device 50 also comprises input/output interface 90 for communicating with external devices, such as a headset, or other input or output devices not shown in FIG. 2. Input/output interface 90 can utilize one or more communication technologies, such as USB, infrared, Bluetooth™, and the like. Haptic interface 92 is arranged to provide tactile feedback to a user of the mobile device. For example, the haptic interface may be employed to vibrate mobile device 50 in a particular way when another user of a mobile device is calling.

Optional GPS transceiver 94 can determine the physical coordinates of mobile device 50 on the surface of the Earth, which typically outputs a location as latitude and longitude values. GPS transceiver 94 can also employ other geo-positioning mechanisms, including, but not limited to, triangulation, assisted GPS (AGPS), E-OTD, CI, SAI, ETA, BSS and the like, to further determine the physical location of mobile device 50 on the surface of the Earth. It is understood that under different conditions, GPS transceiver 94 can determine a physical location within millimeters for mobile device 50; and in other cases, the determined physical location may be less precise, such as within a meter or significantly greater distances.

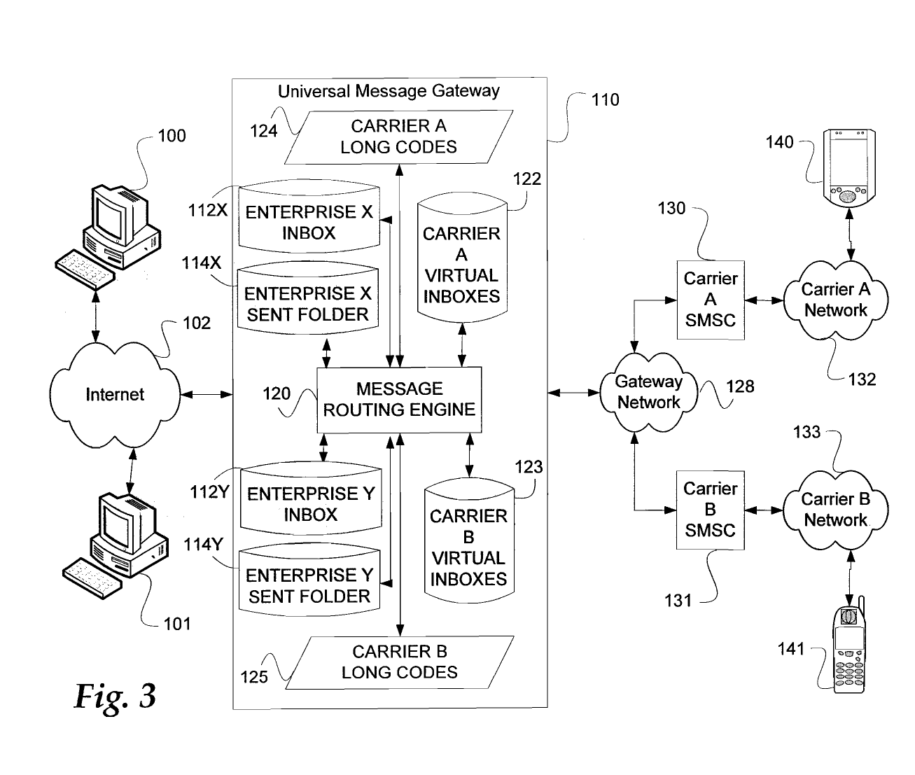

FIG. 3 is a functional block diagram illustrating an overall architecture of an exemplary embodiment of the present invention. In this exemplary embodiment, members of a company, an organization, or other enterprise may wish to share all messages, share messages within a subgroup, or enable at least one primary member to access all messages. For example, a group of dispatchers for a delivery service, who each work a different shift, may wish to maintain messages from delivery drivers in a single “dispatcher” account. In addition, or alternatively, the delivery drivers may need to have access to all messages shared among them and/or shared with the dispatchers. Each member of this exemplary enterprise may also use differing communication systems. Some may communicate through wired networks and others may communicate through different cellular telephone carriers.

Some members of an enterprise may also be members of another enterprise. For example, a driver may work for multiple shipping companies. Each enterprise generally has its own client, or its own enterprise account. Enterprise clients 100 and 101 are shown coupled to internet 102; however, the enterprise clients may communicate through other wired or wireless networks, such as an Ethernet network, a telephone network, and the like. Enterprise clients 100 and/or 101 may comprise a general purpose computing device associated with a company, an organization, or other enterprise. A user of enterprise client 100 or 101 may communicate an original message to a universal message gateways (UMG) 110 for distribution to one or more other users who are associated with the enterprise. UMG 110 may comprise one or more servers and communicate the original message through a gateway network 128 that is coupled one or more communication carriers. For example, gateway network 128 may comprise T3 communication lines coupled to a carrier A short message service center (SMSC) 130 and a carrier B SMSC 131. The original message may then be communicated over a carrier A network 132 to a client 140. Similarly, the original message may be communicated over a carrier B network 133 to a client 141. The carrier networks may comprise wireless and/or wired networks using differing communication protocols, such as those listed above. Each client may return a reply message via UMG 110, which makes the message accessible to, or routes the reply message to the enterprise client 100 or 101 that sent the original message.

Each client device may store the original message in a local inbox. However, UMG 110 also stores the original message in a virtual inbox associate with each client. UMG 110 includes a message routing engine 120 in communication with data stores that comprise carrier A virtual inboxes 122 and carrier B virtual inboxes 123. Carrier A virtual inboxes 122 store messages routed to clients of carrier A. Similarly, Carrier B virtual inboxes 123 store messages routed to clients of carrier B. If the original message was sent by enterprise client 100, the original message may also be stored in an enterprise sent folder 114X that is associated with a messaging account for one or more users of enterprise client 100. Conversely, an enterprise inbox 112X can store messages directed to the enterprise messaging account for enterprise client 100 from clients 140 and 141. Messages in enterprise inbox 112X may be replies or unrelated messages from clients 140 and 141 that are intended for the enterprise associated with enterprise client 100. Similarly, if the original message was sent by enterprise client 101, the original message may be stored in an enterprise sent folder 114Y that is associated with a messaging account for one or more users of enterprise client 101. Conversely, an enterprise inbox 112Y can store messages directed to the enterprise messaging account for enterprise client 101 from clients 140 and 141. Messages in enterprise inbox 112Y may be replies or unrelated messages from clients 140 and 141 that are intended for the enterprise associated with enterprise client 101.

Clients 140 and 141 can each be identified by a client identifier, such as a telephone number, a mobile identification number (MIN), a short code, an IP address, or other identifier. Similarly, an enterprise messaging account associated with one of the enterprises, such as enterprise client 100, can by identified by an enterprise identifier, such as a telephone number, a mobile identification number (MIN), a short code, an IP address, or other identifier. To route messages from the clients to the enterprise accounts, each carrier provides one or more long codes or other enterprise identifiers. In this exemplary embodiment, the clients direct their messages to the long codes, which the carrier SMSCs map to the UMG. If the number of enterprise messaging accounts or enterprise clients becomes large, it may be burdensome for the carriers to provide a unique long code for each enterprise messaging account or enterprise client. The long codes may be in limited supply. Similarly, it may be impractical for the UMG to maintain virtual inboxes for a large number of clients. In this embodiment, each carrier provides a limited number of long codes to UMG 110. Accordingly, UMG 110 stores carrier A long codes 124 and carrier B long codes 125 and makes the long codes available to message routing engine 120. To prevent confusion between duplicate long codes between multiple carriers, each carrier long code may also be associated with a carrier code. A block of long codes from a carrier are also generally divided into sub-blocks of long codes for each enterprise that will communicate through the carrier to clients associated with that enterprise.

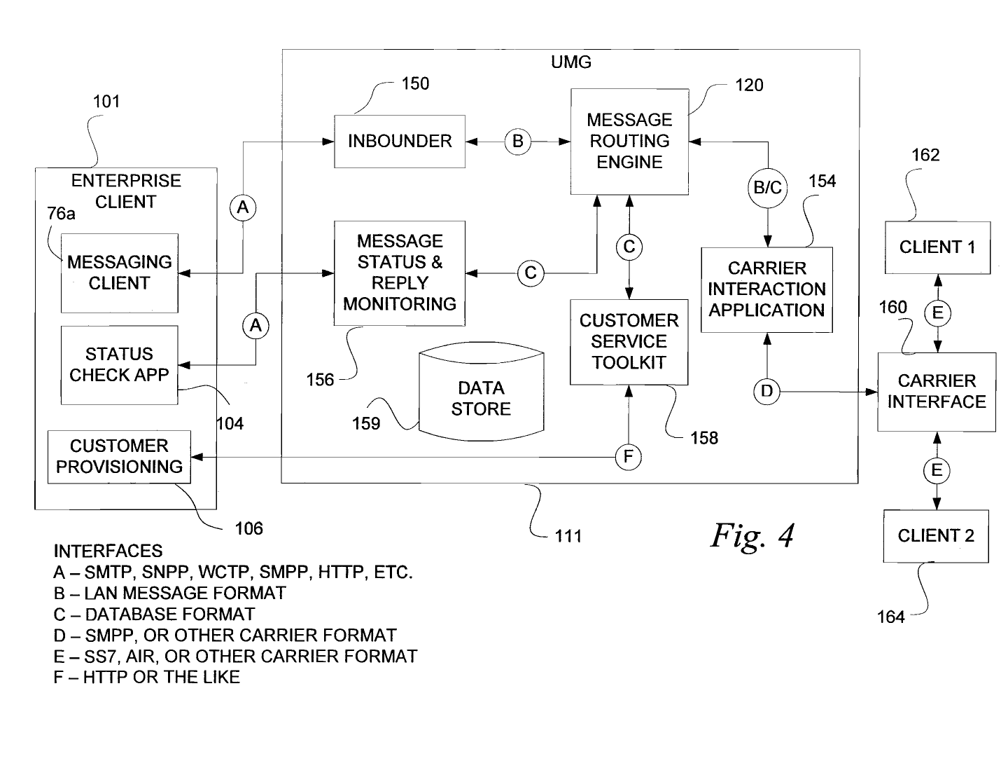

FIG. 4 is a functional block diagram illustrating a more detailed architecture of an exemplary embodiment of the present invention. Enterprise client device 101 may include a messaging client 76a for creating, editing, sending, receiving, and otherwise processing messages. Messaging client 76a may comprise an email client, an instant messaging client, an SMS client, or the like. Enterprise client device 101 may also include a status check application 104 that monitors a UMG 111 for status of sent, received, and/or reply messages.

A customer provisioning application 106 may be a web application that enables an enterprise user to configure settings, such as virtual inboxes for users in an enterprise, security parameters, preferences, billing options, and/or other settings associated with an enterprise messaging account and/or with end client accounts that are associated with the enterprise. Multiple enterprise users can provision the same end client, so that the end client can reply to each enterprise user. Such an end client is sometimes referred to as a multiple-enterprise recipient. A reply from a multiple-enterprise recipient will be delivered to the enterprise that sent the original message. Each enterprise may provision a multiple-enterprise recipient, so that any replies from that recipient are ignored/discarded by UMG 111, and not delivered to the enterprise user that sent the original message. This may be implemented by assigning the multiple-enterprise user to a sub-block 0 of long codes as a “no-reply” code. Similarly, when sending a message, an enterprise may notify UMG 111 that replies to that particular message should be ignored/discarded. The enterprise may also specify limitations on provisioning multiple-enterprise clients. For example, the enterprise user may specify that a multiple-enterprise user must be able to reply, or provisioning for that multiple-enterprise user will fail. Alternatively, the enterprise user may specify that a multiple-enterprise user should be able to reply, but if the multiple-enterprise user can not reply, the provisioning for that multiple-enterprise user will still succeed.

Each module of enterprise client device 101 may communicate with UMG 111 via one or more interfaces. For example, messaging client 76a may communicate with UMG 111 via an HTTP interface, such as that used with a browser.

UMG 111 also includes one or more modules. An inbounder 150 receives an original message from message client 76a of enterprise client device 101. Inbounder 150 may perform a number of preliminary actions, including parsing the received original message to determine the enterprise identifier associated with enterprise client device 101 and to determine one or more client identifiers (e.g., telephone numbers) to which the original message is directed. Inbounder 150 may also validate and/or authenticate the identifiers. Inbounder 150 further assigns a message identifier to the original message. This may be dependent on inbounder 150 determining that the enterprise identifier is validated (and optionally dependent on at least on client identifier being validated). For each client identifier, inbounder 150 checks for an existing virtual inbox and creates a virtual inbox (and optionally a virtual sent folder) for each client identifier that does not already have a virtual inbox. Inbounder 150 also associates the original message identifier with the virtual inbox of each client identifier. Inbounder 150 further associates the original message identifier with a sent folder of the enterprise identifier. The associations may be made in a variety of ways. For example, a database may store the associations, copies of the original message may be stored in the corresponding inboxes and/or in the sent folder, or combinations of database and storage can be used.

Inbounder 150 communicates with a message routing engine 120a via a local area network message routing format such as Ethernet or the like. Message routing engine 120a determines a carrier associated with each client identifier to which the original message is directed. Based on the carrier determined, message routing engine 120a determines a corresponding sub-block of long codes associated with the enterprise client, and selects a long code from those allocated by the determined carrier. For example, a selected long code may be 10101. Message routing engine 120a then assigns the selected long code to the original message. The selected long code is specified as a source identifier for the original message. The source identifier indicates a “from” address of the original message, and correspondingly indicates the address to which any reply should be sent. The client identifier, to which the original message is directed, indicates a “to” address of the message. Since the original message is actually from enterprise client device 101 in this example, message routing engine 120 may also associate a “reply-to” address with the original message. The reply-to address may or may not be added to the original message itself. If not added to the original message, the reply-to address is stored by the message routing engine for later routing a reply to enterprise client device 101.

If all long codes for a determined carrier have already been assigned for a corresponding enterprise, message routing engine 12a selects the long code that has been assigned for the longest period within the sub-block of long codes for the enterprise, and assigns that long code to the received original message. If the newly assigned long code is not associated with the same client identifier, a reply can still be associated with an earlier message. If the newly assigned long code is associated with the same client identifier, the prior association can be deleted, so that a reply to the recent original message is not routed as a reply to the earlier message.

Message routing engine 120 is also in communication with a carrier interaction application 154, using a LAN message format (such as Ethernet) and/or a database communication format (such as SQL). Carrier interaction application 154 reformats, applies headers, or otherwise prepares the original message as necessary for routing to those carriers that are associated with the client identifiers to which the original message is directed. Communication between carrier interaction application 154 and a carrier interface 160 may utilize an SMS-PP protocol or other carrier protocol or format.

Message routing engine 120 further communicates with a message status and reply monitoring application 156 using a database communication format. Message status and reply monitoring application 156 provides status information on sent messages, newly received messages, and reply messages associated with enterprise messaging accounts. Message status and reply monitoring application 156 may validate enterprise client 101 before enabling access to the status information via status check application 104. Similarly, message routing engine 120 communicates with a customer service toolkit 158 using a database communication format. Customer service toolkit 158 enables a user of enterprise client 101 to manage settings via customer provisioning application 106. If customer provisioning application 106 is implemented as a browser based application, it may communicate with customer service toolkit 158 using HTTP. A data store 159 is in communication with one or more of the other modules of UMG 111, using a database communication format. Data store 159 stores long codes, associations among identifiers, inboxes, sent folders, status information, settings, and/or other information.

If an original message is sent as an SMS message to carrier interface 160 (e.g., SMSC), the SMS message is generally forwarded as soon as possible to those clients to which the original message is addressed. Carrier interface 160 would generally not maintain a copy of the original message. If the original message is sent as another type of message, such as an email message to an additional carrier, the corresponding carrier interface may be implemented as a POP3 email server and may maintain a copy of the original message. If the original message is sent to multiple clients via the same carrier, each client identifier is associated with the original message. For example, short codes 555 and 560 may be associated with the original message to identify client 1 162 and client 2 164, respectively. Carrier interface 160 uses the short codes to deliver the original message to the clients using a signaling system 7 (SS7) or other carrier format.

If one or more of the clients return a client message, it is treated in similar manner as the original message. However, message routing engine 120 checks the virtual inbox of the sending client to determine whether it includes a message (e.g., the original message) indicating the long code as a source identifier to which the client message is directed.

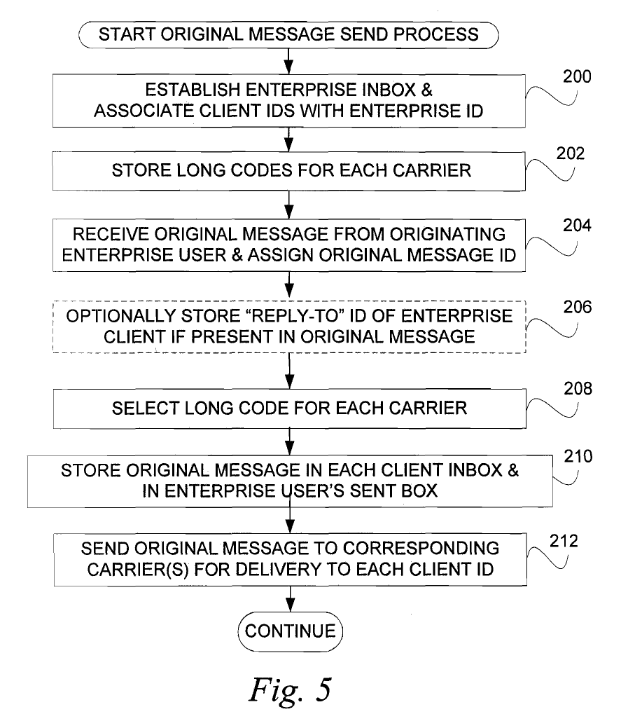

Further detail is provided below with regard to exemplary logic flow diagrams shown in FIGS. 5 through 8. FIG. 5 is a flow diagram illustrating exemplary logic for initiating a message from an enterprise user to one or more other enterprise clients. At an operation 200, for an enterprise, a UMG establishes an enterprise messaging account and corresponding inbox, sent folder, account settings, client provisioning, and other information. Based on provisioning settings, the UMG may set a flag on whether replies will be accepted. One or more sub-groups (sometimes referred to as sub-scopes) may also be established within an enterprise. During this account initialization, one or more telephone numbers and/or other client identifiers are also associated with the enterprise account. This may include an enterprise client identifier for a client device that may be used by a primary message originator. This may not be needed for those enterprise users that access the enterprise account via a browser or otherwise maintain messages at the UMG without needing a client identifier for routing to a mobile device or other client device. The carrier associated with each client identifier may also be determined and stored at this early stage. At an operation 202, a relatively limited number of long codes, short codes, or other enterprise identifiers are obtained from each carrier of the clients associated with the enterprise. In an exemplary embodiment, approximately 10,000 to 100,000 long codes may be a suitable pool of long codes. The larger the number, the easier it is to disambiguate messages sent to a same destination. For multiple enterprises, the enterprise identifiers from each carrier are divided into sub-blocks, and each sub-block associated with an enterprise.

At an operation 204, the UMG receives an original message from an originating enterprise user. The UMG assigns a message identifier to the original message. A transaction identifier may also be assigned to reference information on the direction of communication, targeted client identifiers, or other data. The UMG may optionally store a “reply-to” identifier at an operation 206. The reply-to identifier may be used as an additional address or an alternative address. If only the reply-to identifier is used, return messages or other messages from the other clients may be routed directly to an enterprise client device without storing the return messages in the enterprise inbox. This bypass may reduce storage costs and/or free up space in the enterprise inbox. In either case, the reply-to address may be used to notify the enterprise user of a message before the enterprise user next logs into the UMG to check for messages.

At an operation 208, the UMG evaluates a header or other addressing portion of the original message and determines which carriers are associated with those clients to which the original message is directed. For each carrier, the UMG selects a long code to which messages can be routed back to the UMG from the clients. The same long code can be used for routing the original message to multiple clients served by one carrier. At an operation 210, the UMG stores a relationship between the original message and the virtual inbox of each client to which the original message is directed. The virtual inboxes may not be known to, or accessible by the clients. If storage space is not a concern, the original message may be stored in each virtual inbox. The original message is further associated with the sent folder of the enterprise user that originated the message. A pointer to the enterprise sent folder and/or other header or envelope information may be applied to the original message to make the original message content available to each client. The UMG sends the original message to the identified carriers, at an operation 212, for delivery to each client identified by a client identifier in the original message.

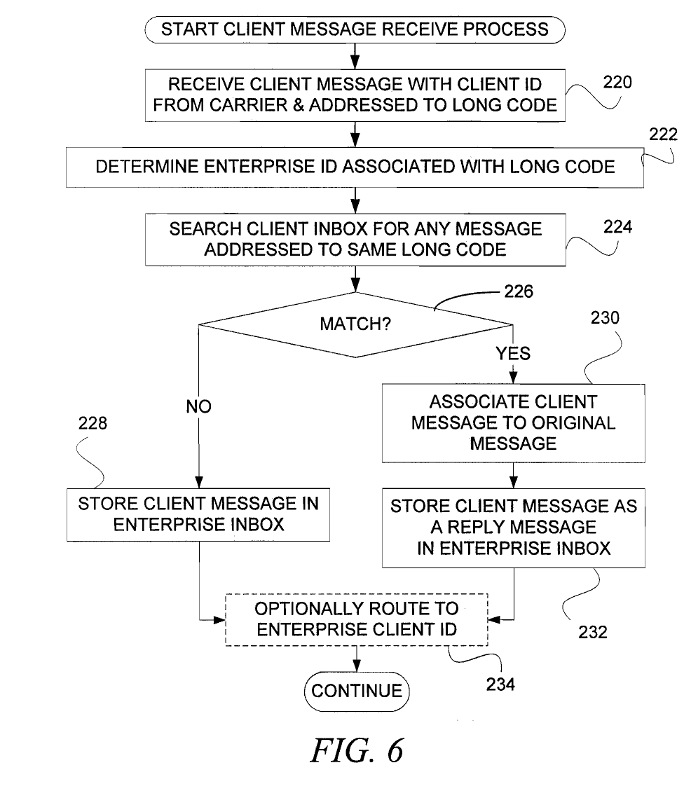

FIG. 6 is a flow diagram illustrating exemplary logic for determining whether a message from an enterprise client is a reply. At an operation 220, the UMG receives a client message that includes a client identifier that identifies the source of the client message. The client message is receive from a carrier and is addressed to the long code allocated by that carrier to the UMG. The UMG assigns a message identifier to the received client message. This message identifier is generally different from the message identifier assigned to the original message. At an operation 222, the UMG evaluates the long code to determine the corresponding enterprise identifier. For multiple-enterprise clients, the long code is within a sub-block to distinguish the enterprise with which the client wishes to communicate.

The UMG also accesses the virtual inbox associated with the client identifier that indicates the source of the client message. The UMG searches the virtual inbox, at an operation 224, for a message that was directed to the client identifier and includes the same long code to which the client message was directed. If no matching message is found at a decision operation 226, the UMG stores the client message in the inbox of the enterprise client as a new, independent message. Conversely, if a matching message is found, the UMG associates the client message with the original message found in the client inbox. More specifically, at an operation 230, the UMG sets a transaction identifier of the client message to the message identifier of the original message. The UMG also adds a header for the client message, providing a pointer to the original message in the enterprise user's sent folder. The UMG further adds a header for the client message, providing a pointer to the original message in the virtual inbox of the client that received the original message and returned the client message.

The UMG also stores the client message, at an operation 232, and an association with the enterprise user's inbox, identifying the client message as a reply. The UMG may apply an arrow icon or other reply indicator, so that the enterprise user will recognize the client message as a reply. The UMG may optionally also route the client message (the reply) to the enterprise client device associated with the enterprise client identifier. The enterprise client identifier may be provided by the reply-to identifier. The enterprise client identifier may also be predefined, so that all replies are routed to a predefined enterprise client device.

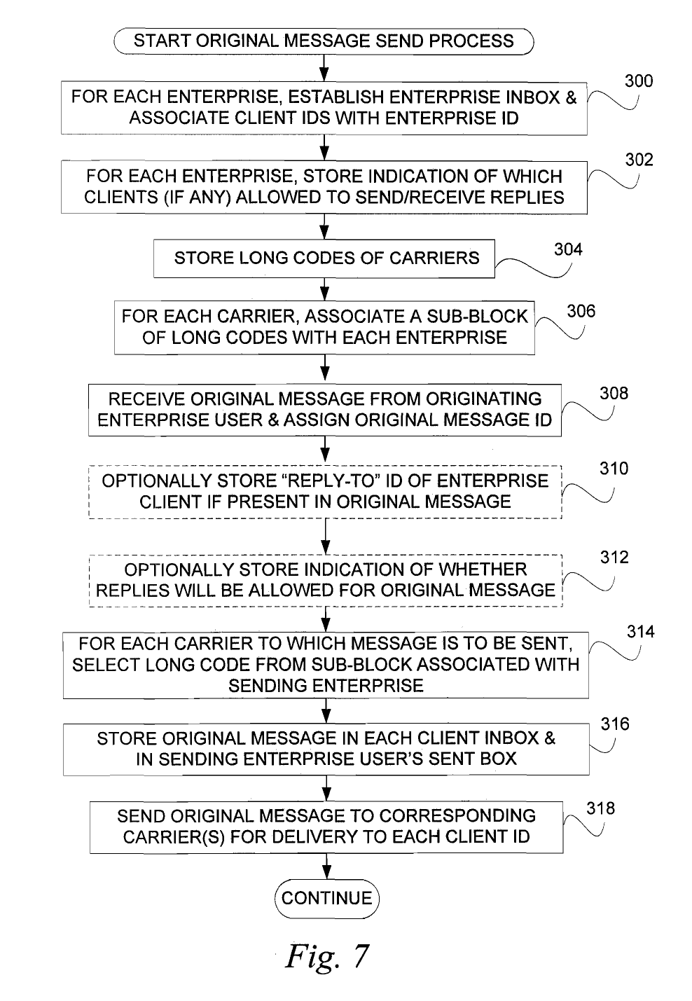

FIG. 7 is a flow diagram illustrating exemplary logic for initiating a message from an enterprise user to one or more other multiple-enterprise clients. At an operation 300, for each enterprise, the UMG establishes an enterprise messaging account and corresponding inbox, sent folder, account settings, and other information. The UMG also associates each enterprise account with client identifiers, such as telephone numbers, for clients that are included in the enterprise. This may include an enterprise client identifier for a client device that may be used by a primary message originator. This may not be needed for those enterprise users that access the enterprise account via a browser or otherwise maintain messages at the UMG without needing a client identifier for routing to a mobile device or other client device. The carrier associated with each client identifier may also be determined and stored at this early stage. The client identifiers may be provided by an enterprise user, determined based on enterprise criteria, or other techniques. Some client identifiers are associated with multiple enterprises. At an operation 302, for each enterprise account, the UMG provisions corresponding client accounts with a reply provision defined by the enterprise account owner. The reply provision may be that one or more client(s) must be able to reply, or the client account will not be created. Alternatively, the reply provision may be that the client(s) should be able to reply, but if the client(s) are not able to reply, the client account(s) should still be provisioned for other uses. In another alternative, the reply provision may be that the client(s) are not allowed to reply.

At an operation 304, a relatively limited number of long codes, short codes, or other enterprise identifiers are obtained from each carrier of the clients associated with the enterprise. In an exemplary embodiment, approximately 10,000 to 100,000 long codes may be a suitable pool of long codes. The larger the number, the easier it is to disambiguate messages sent to a same destination. At an operation 306, the enterprise identifiers from each carrier are divided into sub-blocks, and each sub-block associated with an enterprise. One code can be reserved for individual messages that are flagged such that the UMG will not be accept replies.

At an operation 308, the UMG receives an original message from an originating enterprise user. The UMG assigns a message identifier to the original message. A transaction identifier may also be assigned to reference information on the direction of communication, targeted client identifiers, or other data. The UMG may optionally store a “reply-to” identifier at an operation 310. The reply-to identifier may be used as an additional address or an alternative address. If only the reply-to identifier is used, return messages or other messages from the other clients may be routed directly to an enterprise client device without storing the return messages in the enterprise inbox. This bypass may reduce storage costs and/or free up space in the enterprise inbox. In either case, the reply-to address may be used to notify the enterprise user of a message before the enterprise user next logs into the UMG to check for messages. At an optional operation 312, the UMG determines whether the original message includes a header or other indication that replies are not to be allowed for this original message. The UMG stores this indication for future reference regarding received messages related to this original message.

At an operation 314, the UMG evaluates a header or other addressing portion of the original message and determines which carriers are associated with those clients to which the original message is directed. For each determined carrier, the UMG determines a sub-block of long codes associated with the corresponding carrier and associated with the sending enterprise. From the determined sub-block, the UMG selects a long code to which messages can be routed back from the clients. The same long code can be used for routing the original message to multiple clients served by one carrier.

At an operation 316, the UMG stores a relationship between the original message and the virtual inbox of each client to which the original message is directed. The virtual inboxes may not be known to, or accessible by the clients. If storage space is not a concern, the original message may be stored in each virtual inbox. If replies are allowed for this particular original message, or generally allowed for the sending enterprise, the original message is further associated with the sent folder of the enterprise user that originated the message. A pointer to the enterprise sent folder and/or other header or envelope information may be applied to the original message to make the original message content available to each client. The UMG sends the original message to the identified carriers, at an operation 318, for delivery to each client identified by a client identifier in the original message.

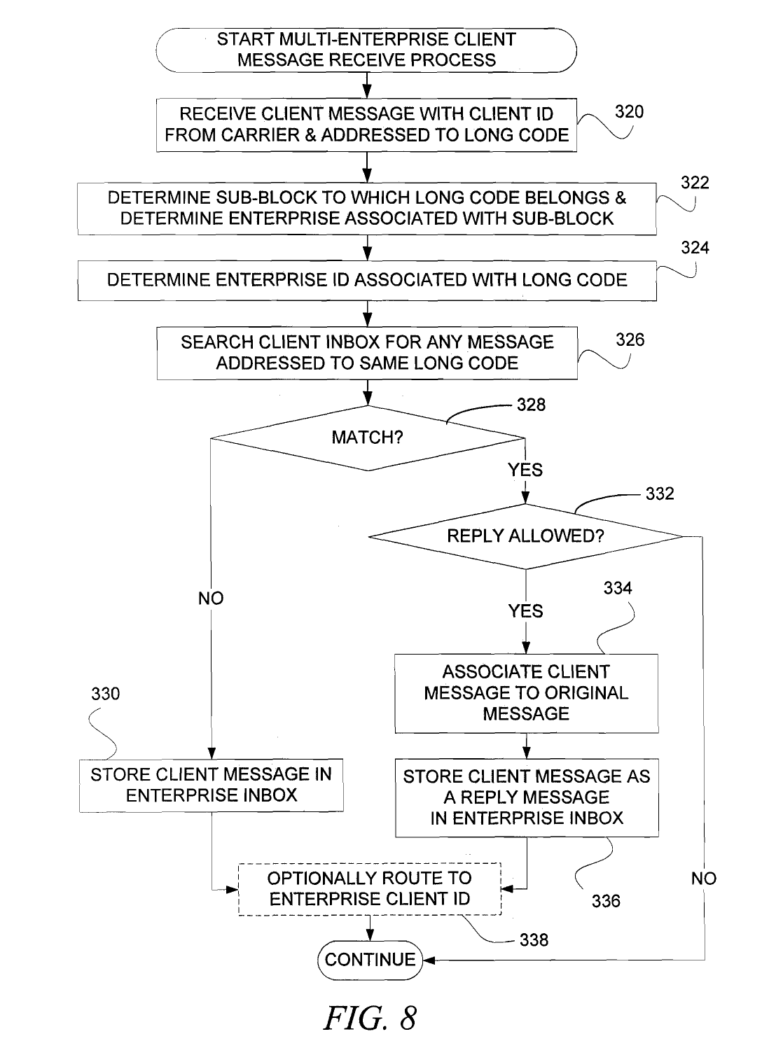

FIG. 8 is a flow diagram illustrating exemplary logic for determining whether a message from a multiple-enterprise client is a reply and routing such a message to the appropriate enterprise account. At an operation 320, the UMG receives a client message that includes a client identifier that identifies the source of the client message. The client message is receive from a carrier and is addressed to the long code allocated by that carrier to the UMG. At an operation 322, the UMG evaluates the long code to determine a sub-block to which the long code belongs. Based on the sub-block, the UMG determines the enterprise that is associated with that sub-block. The UMG assigns a message identifier to the received client message. This message identifier is generally different from the message identifier assigned to the original message. At an operation 324, the UMG determines the particular enterprise identifier associated with the long code within the determined sub-block.

The UMG also accesses the virtual inbox associated with the client identifier that indicates the source of the client message. The UMG searches the virtual inbox, at an operation 326, for a message that was directed to the client identifier and includes the same long code, within the same sub-block, to which the client message was directed. If no matching message is found at a decision operation 328, the UMG stores the client message in the inbox of the enterprise client as a new, independent message.

Conversely, if a matching message is found, the UMG determines, at a decision operation 332, whether a reply is allowed, based in prior provisioning. If a reply is not allowed for the particular original message, or if a reply is not allowed for the enterprise identifier, the client message is deleted or otherwise ignored. If a reply is allowed, the UMG associates the client message with the original message found in the client inbox. More specifically, at an operation 324, the UMG sets a transaction identifier of the client message to the message identifier of the original message. The UMG also adds a header for the client message, providing a pointer to the original message in the enterprise user's sent folder. The UMG further adds a header for the client message, providing a pointer to the original message in the virtual inbox of the client that received the original message and returned the client message.

The UMG also stores the client message, at an operation 336, and an association with the enterprise user's inbox, identifying the client message as a reply. The UMG may apply an arrow icon or other reply indicator, so that the enterprise user will recognize the client message as a reply. The UMG may optionally also route the client message (e.g., new message, or the reply) to the enterprise client device associated with the enterprise client identifier. The enterprise client identifier may be provided by the reply-to identifier. The enterprise client identifier may also be predefined, so that all replies are routed to a predefined enterprise client device.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for identifying a reply message, comprising:
associating a first message with a source identifier selected from a sub-block of a plurality of sub-blocks of a relatively limited number of identifiers allocated by a communication carrier, wherein the source identifier identifies a source of the first message, and wherein each sub-block is associated with one of a plurality of enterprises, each enterprise comprising a plurality of users;
associating the first message with a client inbox that is associated with a client identifier of a client to which the first message is directed, wherein the client is associated with at least two of the plurality of enterprises;
receiving a second message directed to the source identified by the source identifier and wherein the second message is identified as from the client identified by the client identifier; and
identifying the second message as a reply message if the client inbox is associated with a message identified as from the source by the source identifier within the sub-block.

2. The method of claim 1, wherein the inbox is a virtual inbox maintained by a message gateway that interfaces with a plurality of communication carriers.

3. The method of claim 1, further comprising routing the second message to the source of the first message, wherein the source comprises another client.

4. The method of claim 1, further comprising identifying the second message as a new message if the client inbox does not include a message identified as from the source by the source identifier within the sub-block.

5. The method of claim 1, wherein the first message and the second message conform to at least one of the following; a short message service—point to point protocol, a multimedia service protocol, a simple network paging protocol, a simple mail transport protocol, a post office protocol, a wireless content transport protocol, and a hypertext transport protocol.

6. The method of claim 1, wherein the client identifier comprises one of the following; a telephone number, a mobile identification number, an internet protocol address, and a messaging account user identifier.

7. The method of claim 1, wherein the source identifier comprises a long code.

8. The method of claim 1, further comprising assigning a message identifier to the first message and associating the message identifier with the second message to identify the second message as a reply.

9. The method of claim 1, further comprising appending the second message to the first message.

10. A computer readable medium storing computer executable instructions that enable an electronic device to perform the actions of claim 1.

11. A system for identifying a reply message, comprising:
a communication interface;
a processor in communication with the communication interface; and
a memory storing machine readable instructions that cause the processor to perform at least the actions of:
associating a first message with a source identifier selected from a sub-block of a plurality of sub-blocks of a relatively limited number of identifiers allocated by a communication carrier, wherein the source identifier identifies a source of the first message, and wherein each sub-block is associated with one of a plurality of enterprises, each enterprise comprising a plurality of users;
associating the first message with a client inbox that is associated with a client identifier of a client to which the first message is directed, wherein the client is associated with at least two of the plurality of enterprises;
receiving a second message directed to the source identified by the source identifier and wherein the second message is identified as from the client identified by the client identifier; and
identifying the second message as a reply message if the client inbox is associated with a message identified as from the source by the source identifier within the sub-block.

12. The system of claim 11, wherein the inbox is a virtual inbox and the communication interface interfaces with a plurality of communication carriers.

13. The system of claim 11, wherein the machine readable instructions further cause the processor to perform the action of routing the second message to the source of the first message, wherein the source comprises another client.

14. The system of claim 11, wherein the machine readable instructions further cause the processor to perform the action of identifying the second message as a new message if the client inbox does not include a message identified as from the source by the source identifier within the sub-block.

15. The system of claim 11, wherein the first message and the second message conform to at least one of the following; a short message service—point to point protocol, a multimedia service protocol, a simple network paging protocol, a simple mail transport protocol, a post office protocol, a wireless content transport protocol, and a hypertext transport protocol.

16. The system of claim 11, wherein the client identifier comprises one of the following; a telephone number, a mobile identification number, an internet protocol address, and a messaging account user identifier.

17. The system of claim 11, wherein the source identifier comprises a long code.

18. The system of claim 11, wherein the machine readable instructions further cause the processor to perform the action of assigning a message identifier to the first message and associating the message identifier with the second message to identify the second message as a reply.

19. The system of claim 11, wherein the machine readable instructions further cause the processor to perform the action of appending the second message to the first message.

20. A system for identifying a reply message, comprising:
a virtual inbox storing a first message associated with a source identifier selected from a sub-block of a plurality of sub-blocks of a relatively limited number of identifiers allocated by a communication carrier, wherein the source identifier identifies a source of the first message, and wherein the first message is associated with a client identifier of a client to which the first message is directed, wherein the client is associated with at least two of a plurality of enterprises and each enterprise is associated with one sub-block of the plurality of sub-blocks; and
a message routing engine that:
receives a second message directed to the source identified by the source identifier and wherein the second message is identified as from the client identified by the client identifier; and
identifies the second message as a reply message if the virtual inbox is associated with a message identified as from the source by the source identifier.
